(19) United States
(12) Patent Application Publication
(10) Pub. No.: US 2004/0197499 A1
(43) Pub. Date: Oct. 7, 2004

(54) System for mounting a laminate

(75) Inventor: Rafael Horta, Miami, FL (US)

Correspondence Address: IP Department, Schnader Harrison Segal & Lewis, 36th Floor, 1600 Market Street, Philadelphia, PA, 19103, US

(73) Assignee: Arch Aluminum & Glass Co.

(21) Appl. No.: 10/404,637

(22) Filed: Apr. 3, 2003

(51) Int. Cl. B32B 1/08

(52) U.S. Cl. 428/34.1; 428/36.9

(57) ABSTRACT

The invention is directed to a laminate mounting system that incorporates a method and apparatus for mounting a substantially translucent laminate to a support, wherein the laminate comprises at least one layer of a material bonded to an interlayer of a thermoplastic polymer, which may include a mounting member for attaching the laminate to a support, the mounting member having at least one metallic recess proximate a surface thereof for receiving the thermoplastic polymer and bonding thereto. The metallic recess may comprise and elongated cavity, such as a dovetail cavity, that may be formed in the surface of the mounting member or along a protrusion formed thereon.

### FIELD OF THE INVENTION

The field of the invention concerns the mounting of laminated sheets, particularly the bonding of materials to a laminated glass structure, and more particularly to the mounting of laminated glass structures that can withstand severe impact.

### BACKGROUND

High velocity winds, such as those create during a bomb blast or a hurricane, can cause severe damage to persons and property, particularly due to the high force impact of object against windows, which often causes them to shatter explosively. Consequently, threat-resistant windows and glass structures have been developed to address this problem.

For example, U.S. Pat. No. 5,960,606 and U.S. Pat. No. 4,799,376 each describes laminate windows that are made to withstand severe forces. In International Patent Application No. WO 98/28515, a glass laminate is positioned in a rigid channel in which a resilient material adjacent to the glass permits flexing movement between the resilient material and the rigid channel. Other means of holding the panels also exist, such as adhesive tapes, gaskets, putty, and the like.

These windows and glass structures may be improved. For example, severe winds may cause a flexing movement in the windows so that the glass flexes within a rigid channel. This gradually pulls the laminate out of the channel, resulting in loss of integrity of the structure. Consequently, the glass held against the frame may be broken and crushed, causing a loss of structural integrity in the window/frame structure.

One way in which this has been addressed is through the use of a glazing element to secure a transparent laminate to a structural support, such as is disclosed in International Patent Application No. WO 00/64670. The laminate comprises at least one layer of glass that is self-adhered directly to the layer of glass using a thermoplastic polymer having a low haze, wherein the layer of thermoplastic polymer is attached to the structural support along the edges of the laminate.

However, other improvements would be beneficial to even further minimize the risk to persons and property due to high winds and impacting debris.

### SUMMARY OF THE INVENTION

Embodiments of the invention include an apparatus for mounting a substantially translucent laminate to a support, wherein the laminate comprises at least one layer of a material bonded to an interlayer of a thermoplastic polymer, which may include a mounting member for attaching the laminate to a support, the mounting member having at least one metallic recess proximate a surface thereof for receiving the thermoplastic polymer and bonding thereto. The metallic recess may comprise an elongated cavity, such as a dovetail cavity, that may be formed in the surface of the mounting member or along a protrusion formed thereon.

The thermoplastic polymer is preferably an ionomer resin, such as a water insoluble sodium salt of a polymer of ethylene and methacrylic acid or acrylic acid containing 14-24% by weight of the acid and having about 30-50% by weight of the acid neutralized with sodium ion and the ionomer resin has a melt index of about 0.5-50.

Another embodiment of the invention includes a laminate mounting system having a substantially translucent laminate comprising at least one layer of material bonded to an interlayer of a thermoplastic polymer, and a plurality of mounting members for attaching the laminate to a support, each of the mounting members having at least one metallic recess proximate a surface thereof for receiving the thermoplastic polymer and bonding thereto.

The mounting member may include a channel for attaching to the support, and the system may include a cover member for attaching at least one of the mounting members to the support, where the cover member has at least one flange thereon for removeably engaging the channel in the mounting member. An outer casing may also be provided for concealing the cover member and at least one of the mounting members, and at least one rubber gasket may be used for substantially sealing the laminate against the support.

### BRIEF DESCRIPTION OF THE DRAWINGS

FIG. 1 is a drawing illustrating a preferred embodiment of a laminate mounting system in accordance with the invention.

FIGS. 2(a)-(f) are cutaway views of portions of FIG. 1, illustrating preferred embodiments of laminate mounting members in accordance with the invention.

### DETAILED DESCRIPTION

The invention will be understood more fully from the detailed description given below and from the accompanying drawings of preferred embodiments of the invention; which, however, should not be taken to limit the invention to a specific embodiment but are for explanation and understanding only.

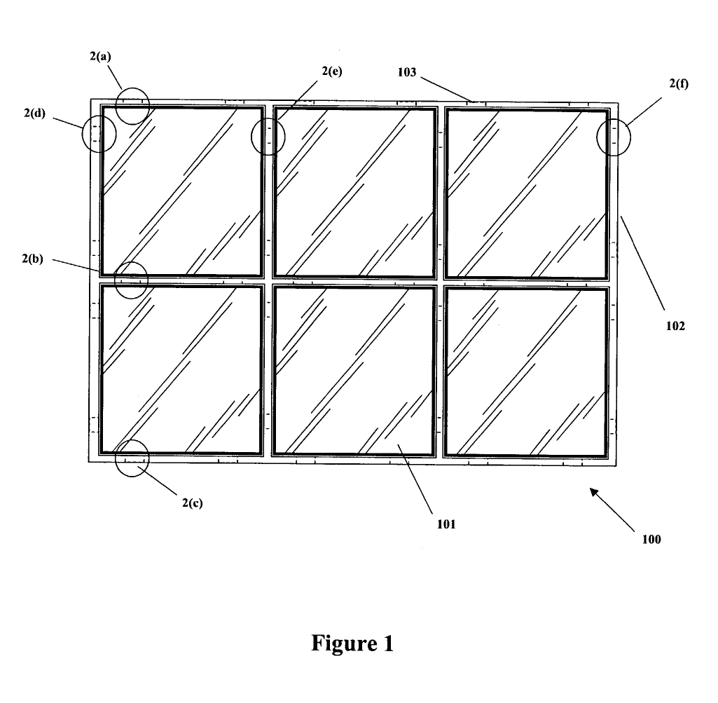

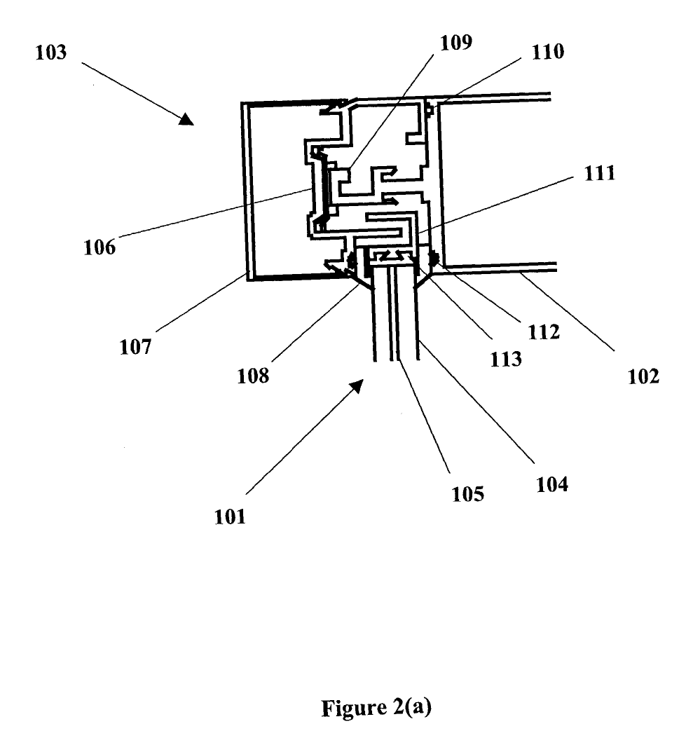

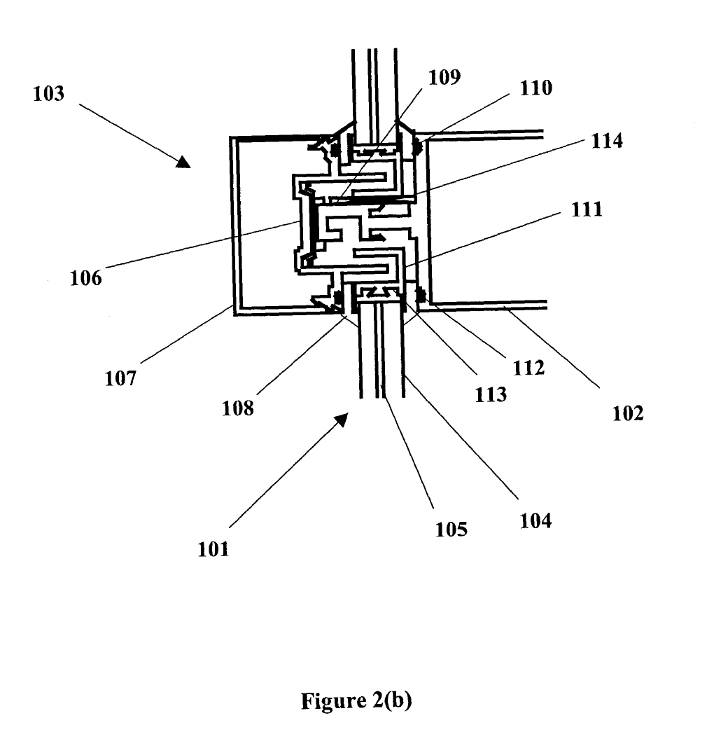

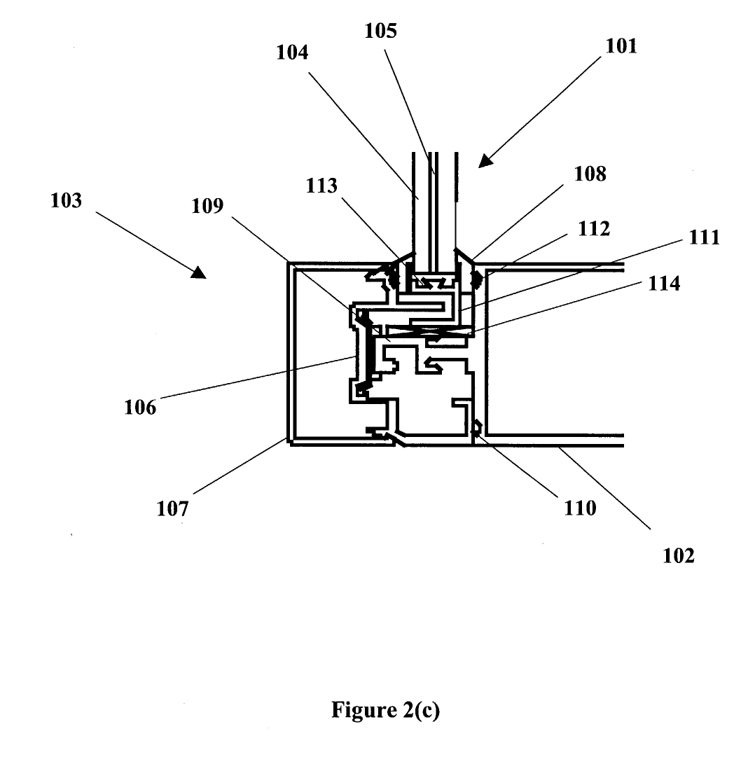

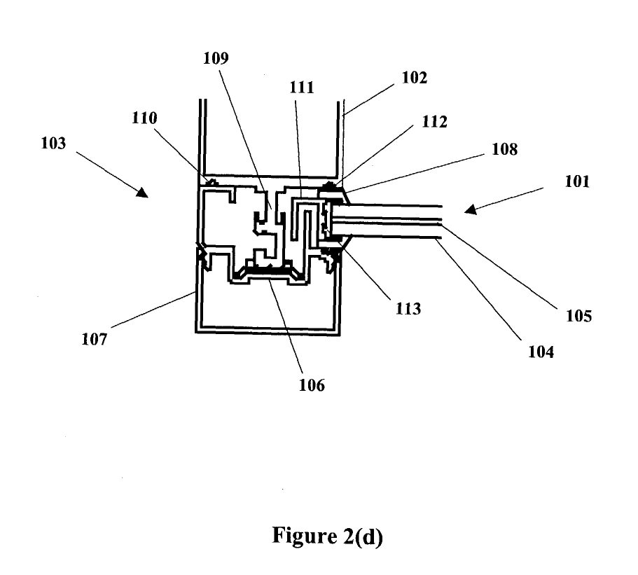

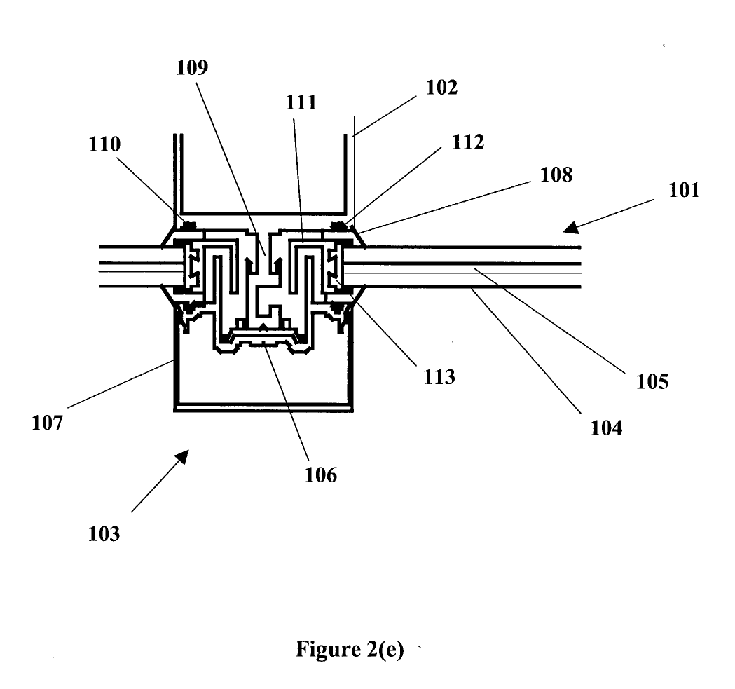

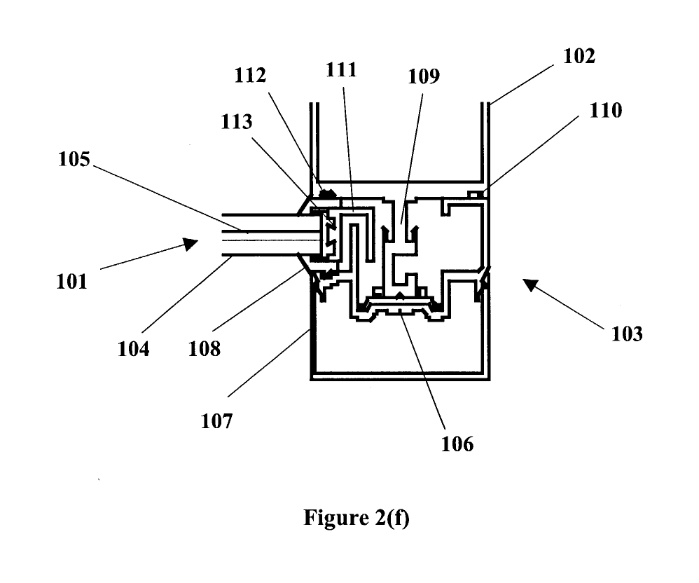

A preferred embodiment of the invention is illustrated in FIG. 1 and FIGS. 2(a)-(f) In the system of the invention (100), a laminate (101), comprising one or more layers of a substantially translucent material (104), such as glass or various polymers, is attached directly to a frame support (102) using a plurality of couplings (103). Frame support (102) may be fabricated from a variety of materials such as, wood, aluminum, steel, and various strong plastics including polyvinyl chloride and nylon.

Laminate (101) is preferably attached directly to support (102) through interlayer (105) to provide improved integrity. Attachment of interlayer (105) to support (102) may be from the top, sides, bottom, or through interlayer (105), as shown. While support (102) illustrated herein is a frame that surrounds the laminate (101), it will be appreciated by those of ordinary skill in the art that other support structures or means may be used as well. While the invention is described herein in connection with a 2×4 laminate arrangement, it will be appreciated that the invention is not limited thereto and may be used with any configuration of laminates or a single laminate.

In one embodiment, laminate (101) preferably comprises at least one layer of glass having an interlayer formed thereon from a thermoplastic polymer having low haze, wherein the outer edges of the interlayer polymer are attached to a surrounding frame. In another embodiment, laminate (101) is a transparent laminate of two layers of glass with an intermediate thermoplastic polymer interlayer self-adhered to at least one of the glass surfaces. The interlayer preferably has a Storage Young's Modulus of 50-1,000 MPa at 0.3 Hz at 25° C., as determined according to ASTM D 5026-95a. Of course, it will be appreciated by those of ordinary skill in the art that the invention is not limited thereto and may be used with any materials capable of being laminated in accordance with the invention, such as various polymer sheets.

Preferably, interlayer (105) is a sheet of an ionomer resin, wherein the ionomer resin is a water insoluble salt of a polymer of ethylene and methacrylic acid or acrylic acid, containing about 14-24% by weight of the acid and about 76-86% by weight of ethylene. The ionomer further preferably has about 10-80% of the acid neutralized with a metallic ion, preferably a sodium ion, and the ionomer has a melt index of about 0.5-50 determined at 190° C. according to ASTM D 1238. Known methods may be used to obtain an ionomer resin with suitable optical properties. It is preferred that the thermoplastic polymer interlayer be self-adhered directly to glass, without any intermediate layer between the thermoplastic polymer layer and the glass.

Standard techniques may be used to form resin interlayer (105). For example, compression molding, injection molding, extrusion and/or calendaring can be used. Preferably, conventional extrusion techniques are used. Additives such a colorants, antioxidants and UV stabilizers may be melt blended and passed through a filter for contamination removal. Typical colorants that may be used include, for example, a bluing agent to reduce yellowing or a whitening agent or a colorant can be added to color the glass or to control solar light.

Laminate (101) may be prepared according to conventional processes known in the art. In a typical process, the interlayer is placed between two pieces of annealed float glass, which have been washed and rinsed in demineralized water. Interlayer (105) is preferably exposed during manufacture of the laminate in such a manner that it may later be attached to surrounding frame (102) as described below. This may be accomplished, for example, by extending the edges of the resin sheet into the frame by including a strip of resin sheet into the frame from each edge of the glass. Air may be removed from between the layers of laminate (101), and interlayer (105) may be bonded to the glass plates by applying heat and pressure to the structure. Alternatively, the interlayer may be bonded without applying increased pressure to the structure.

Once assembled, the laminate is then heated in an oven set at about 90-100° C. for about 30 minutes. Thereafter, it is rolled pressed so that most of the air in the void spaces between the glass and the interlayer may be squeezed out, and the edge of the assembly sealed. The assembly is then placed in an air autoclave where the temperature is raised to about 135° C. and pressure to about 200 psig (14.3 bar). These conditions are maintained for about 20 minutes, after which, the air is cooled while no more air is added to the autoclave. After cooling (anywhere from 20 minutes to several hours), when the air temperature in the autoclave is less than about 50° C., the excess air pressure is vented. Alternatively, ambient atmospheric pressure may be used throughout.

Interlayer (105) preferably has a Storage Young's Modulus of from about 50 to about 1,000 MPa and preferably form about 100 to about 500 MPa, as determined according to ASTM D 5026-95a. The interlayer should remain in the 50-1,000 MPa range of its Storage Young's Modulus at temperatures up to 40° C.

Once formed, laminate (101) is preferably joined to frame (102) in the manner illustrated in FIGS. 2(a)-(f). The portion of interlayer (105) that extends beyond the end of laminate (101) is heated so that it preferably fills recesses (113) of mounting members (111), securing mounting member (111) to laminate (101). Each mounting member (111) is preferably a U-shaped channel, having elongated groove or recesses along one side for attachment to laminate (101). In the example shown, recesses (113) are formed as a plurality of dovetail cavities in mounting member (111). The dovetail cavities have angled sidewalls, which produces recesses that help to grip and adhere the interlayer material to mounting member (111). The use of a plurality of such cavities in the particular formation shown creates a center protrusion along which has a recess on either side thereof. However, those of ordinary skill in the art will appreciate that other configurations for recesses (113) are possible.

In the preferred embodiment, a plurality of short mounting members (111) are fastened around the outside edges of laminates (101), although a continuous mounting member may also be used. Mounting member (111), or at least recesses (113) contained therein, is preferably metallic, and more preferably aluminum, although other metals may possibly be used. This better allows the resin of interlayer (105) to adhere to mounting member (111). It is also preferred that the resin of the exposed portion of interlayer (105) is uniformly heated when adhering it to mounting member (111). This may be accomplished, for example, by heating mounting member (111) within a confined space, such as by encasing mounting member (111) in a box during and attaching a hot blower thereto.

Frame (102) may include an elongated C-channel (109) onto which mounting cover plate (106) may be fastened. The manner in which mounting cover plate (106) may be fastened to C-channel (109) is not particularly limited, and may include, for example, screwing or nailing. Mounting cover plate (106) preferably includes a flange along one edge thereof for engaging the U-channel of mounting member (111). Mounting cover plate (106) may also include a small prong (110), which fits into a groove along the length of support (102) for better aligning mounting plate (106) therewith.

Rubber gaskets (108) may be used for sealing laminate (101) to support (102). Rubber gaskets (108) may be affixed, for example, by inserting prongs (112) into grooves contained in support (102) and/or mounting cover plate (106), although not limited thereto. For the portions of the mounting structure that will be bearing the weight of laminate (101), a cushions (114) may preferably be provided to further support mounting member (111). Cushion (114) may comprise any material capable of supporting and cushioning mounting member (111), such as rubber, plastic foam, etc. An outer casing (107) may also be included for hiding the mounting structure and providing an visual facade.

For architectural uses in coastal areas, the system of the invention should pass a simulated hurricane impact and cycling test, which measures resistance of a laminate to debris impact and wind pressure cycling.

Although this invention has been described with reference to particular embodiments, it will be appreciated that many variations may be resorted to without departing from the spirit and scope of this invention.

What is claimed is:

1. An apparatus for mounting a substantially translucent laminate to a support, wherein said laminate comprises at least one layer of a material bonded to an interlayer of a thermoplastic polymer, said apparatus comprising:
a mounting member for attaching said laminate to said support, said mounting member having at least one metallic recess proximate a surface thereof for receiving said thermoplastic polymer and bonding thereto.

2. The apparatus of claim 1, wherein said metallic recess comprises a cavity formed in said surface of said mounting member.

3. The apparatus of claim 2, wherein said cavity is elongated.

4. The apparatus of claim 1, wherein said metallic recess is a dovetail cavity.

5. The apparatus of claim 1, wherein said metallic recess is formed along a protrusion extending from said surface of said mounting member.

6. The apparatus of claim 4, wherein said metallic recess is elongated.

7. The apparatus of claim 1, wherein said mounting member further comprises a channel for attaching to said support.

8. The apparatus of claim 7, wherein said channel is elongated.

9. The apparatus of claim 1, wherein said thermoplastic polymer is an ionomer resin.

10. The apparatus of claim 9, wherein said ionomer resin consists essentially of a water insoluble sodium salt of a polymer of ethylene and methacrylic acid or acrylic acid containing 14-24% by weight of the acid and having about 30-50% by weight of the acid neutralized with sodium ion and the ionomer resin has a melt index of about 0.5-50.

11. The apparatus of claim 1, wherein said layer of material has a tin-side and an air-side, wherein said tin-side is bonded said thermoplastic polymer.

12. A laminate mounting system comprising:
a substantially translucent laminate comprising at least one layer of material bonded to an interlayer of a thermoplastic polymer, said apparatus comprising:
a plurality of mounting members for attaching said glass laminate to a support, each of said mounting members having at least one metallic recess proximate a surface thereof for receiving said thermoplastic polymer and bonding thereto.

13. The system of claim 12, wherein said metallic recess is a dovetail cavity.

14. The system of claim 12, wherein said mounting member includes a channel for attaching to said support, and said system further comprises a cover member for attaching at least one of said mounting members to said support, said cover member having at least one flange thereon for removeably engaging said channel in said mounting member.

15. The system of claim 14, further comprising an outer casing for concealing said cover member and at least one of said mounting members.

16. The system of claim 12, further comprising at least one rubber gasket for substantially sealing said laminate against said support.

17. The apparatus of claim 12, wherein said thermoplastic polymer is an ionomer resin.

18. The apparatus of claim 17, wherein said ionomer resin consists essentially of a water insoluble sodium salt of a polymer of ethylene and methacrylic acid or acrylic acid containing 14-24% by weight of the acid and having about 30-50% by weight of the acid neutralized with sodium ion and the ionomer resin has a melt index of about 0.5-50.

19. A process for making a substantially translucent laminate comprising the steps of:
positioning a thermoplastic polymer interlayer between two plates of substantially translucent material: wherein said thermoplastic polymer is exposed to allow for attachment of said laminate at least one mounting member;
positioning said exposed polymer proximate at least one metallic recess proximate a surface of said mounting member; and
bonding said plates to said interlayer to said metallic recess of said mounting member using said thermoplastic polymer.

20. The process of claim 19, further comprising step of:
substantially encasing said metallic recess and said exposed thermoplastic polymer; and
substantially uniformly heating said metallic recess and said exposed thermoplastic polymer to bond said thermoplastic polymer to said metallic recess.
